(19) United States
(12) Patent Application Publication
(10) Pub. No.: US 2019/0119465 A1
(43) Pub. Date: Apr. 25, 2019

(54) POWDER FREE NITRILE GLOVE AND ITS COMPOSITION

(71) Applicant: TWOLINK SDN BHD, SHAH ALAM (MY)

(72) Inventors: JENN CHUAN CHIA, KLANG (MY); SHAHRATUL AIN MOHD SUKRI, SHAH ALAM (MY)

(21) Appl. No.: 15/863,142

(22) Filed: Jan. 5, 2018

(30) Foreign Application Priority Data
Oct. 20, 2017 (MY) PI 2017703975

(51) Int. Cl. C08K 5/06; C08K 3/28; C08K 5/098; C08K 5/01; C08J 3/26; A41D 19/00

(52) U.S. Cl. CPC C08K 5/06; C08K 3/28; C08K 5/098; C08K 5/01; C08J 2355/02; A41D 19/0082; C08K 2003/287; C08K 2201/014; C08K 2003/282; C08J 3/26

(57) ABSTRACT

A nitrile glove made from dipping in a powder free coagulant solution comprising of 8-30% calcium salt, 0.1-1.0 aluminum salt and 0.1-1.0% nonionic surfactant; and a carboxylated nitrile latex optionally comprising of 0.1-2.0 phr wax.

### FIELD

The present invention relates to compositions of powder free nitrile glove and the method of making it.

### BACKGROUND

### CITED PATENTS

U.S. Pat. Nos. 2,378,693, 2,469,827, 2,919,256, 5,534,350, 5,993,923, 6,075,081, 6,939,617, 5,838,9620, US20040022980A1, US20080311409A1

It is a well known and commonly used skill of applying multi-valent metal salt such as divalent calcium salt and tri-valent aluminum salt or their mixtures as a coagulant to solidify natural or synthetic rubber latex such as described in U.S. Pat. Nos. 2,378,693, 2,469,827 and 2,919,256. This skill has also been applied in making glove for a long time, where a glove ceramic former is dipped in metal salts coagulant solution containing powder such as talc and calcium carbonate which act as a release agent or lubricant to coat a layer of coagulant after dried, and then dipped in compounded rubber latex to solidify and form a layer of rubber film on the former, and further using water for leaching out impurities such as water dissolvable metal salts and surfactants. After that it goes through a hot oven for curing rubber film, followed by powder surface treatment to prevent the made gloves from sticking together and to improve donnability before stripping from the former. When stripping the glove from the former, the glove is turned inside-out. The outside surface is the surface contacted with the coagulant and former during manufacturing process, where the glove industry called it working surface which contact object during using; meanwhile another side surface is called donning surface which contact the wearer's hand skin. The powdered glove if contacted with bacteria and the light weight powder may bring together and fly into the air, it can cause cross-contamination health risks. To overcome this concern, glove industry has developed many possible solutions of making powder free glove such as U.S. Pat. Nos. 5,534,350, 5,993,923, 6,075,081, 6,352,666, 20040022980A1 and US20080311409A1 by using various binder such as polyurethane, acrylic and chloroprene polymer or by using lubricant such as wax and silicone in the coagulant to substitute powder and intended to form a layer of powder free lubricant layer on the glove working surface. Unfortunately, part of these binders and lubricants residues are left on the former and contaminated the former which are extremely difficult to clean and it caused re-coating problems.

Glove industry commonly use conventional chlorination or polymer coating method by coating a binder polymer with lubricants on the glove donning surface. By using these two methods, the chemicals do not contact former which cause contamination and re-coating problems. For powder free working surface treatment, the glove industry commonly used metallic stearate powder to substitute calcium carbonate to reduce the powder residue content. However, the metallic stearate may react with calcium salt of the coagulant to form soap scums which can contaminate the former and are difficult to clean.

U.S. Pat. No. 6,939,617 described the use of calcium and aluminum salts mixtures solution as a coagulant to make a non-adhesive working surface of nitrile products, this prior art also pointed out that the presence of aluminum salts in calcium salt based coagulant can lead to the deterioration of the nitrile rubber film strength which is caused by the aluminum salt that had diffused into rubber film and consequently it become over-vulcanized and develop film cracks problems. To overcome this problem, U.S. Pat. No. 5,693,917 described by using inorganic aluminum compounds with many kinds of non-adhesive carboxyl-group blocking agent and U.S. Pat. No. 8,389,620 described by adding organic carboxyl-hydroxyl aluminum compound and further with many kinds of organic crosslinkers in the carboxylated nitrile latex to avoid the impact of inorganic aluminum salt of coagulant. Unfortunately, both approaches are too complicated to apply in currently production process. The present invention herein discloses a simple, effective and cost saving solution to overcome this problem.

### SUMMARY

The present invention provides a simple and effective method by adding a nonionic surfactant in calcium and aluminum salt water based solution as a powder free coagulant to make a non-adhesive working surface of nitrile glove without scarifying glove strength and further adding with a wax in carboxylated nitrile latex to adjust the working surface grip strength. By using this method, it can provide additional advantages such as simplifying the former cleaning process and chemicals used while also extending the former service life. This method can work with most of carboxylated rubber latex such as styrene butadiene rubber and acrylonitrile butadiene rubber and crosslinking agents such as sulfur base, peroxide, tri- or tetravalent metallic base, and polyfunctional organic compounds to enlarging the application range.

### DETAILED DESCRIPTION

According to U.S. Pat. Nos. 6,939,617 or 8,389,620 descriptions that by using aluminum salt as a coagulant, only a very thin film is obtained. On the other hand, adding a zinc salt in calcium salt solution as a coagulant is not able to make a non-adhesive working surface of nitrile rubber film. Meanwhile, by adding aluminum salt in calcium salt based coagulant can make a non-adhesive working surface but with a poor film strength. After examination and tests, our results confirmed that it corresponds with the above-mentioned phenomena. It is also noticed that there is no nonionic surfactant added in the calcium and aluminum salt coagulant solution based on both previous patents. In theory, whether mono- or di- or trivalent metal ion such as potassium, zinc and aluminum which is added in carboxylated nitrile latex, can react with carboxylic acid to form ionic crosslinking bond and enforce the rubber film strength. The conventional method of preparing compounded latex adds various additives such as covalent bond crosslinker, ionic bond crosslinker, dispersing agent, titanium dioxide, stabilizer, color dye and etc., in carboxylated nitrile latex and continuously agitating for about 18-48 hours of maturation time to allow the metallic crosslinker to react and form ionic crosslinking bond slowly under a room temperature condition for improving the wet gelling film strength. Also, it is commonly added anionic or nonionic surfactants such as sodium dodecylbenzenesulfonates and polyethylene glycol that act as a stabilizer to prevent from early latex gelation condition during maturation, and to prevent calcium ion of coagulant from diffusing into compounded latex tank during dipping process which can cause increase in viscosity or lumps issues. Based on the teaching of surfactant functionality to metallic ion and the question of lacking addition of such surfactant in calcium and aluminum salt coagulant, we made a trial by adding nonionic surfactant which is a condensation product of ethylene oxide and a long chain fatty alcohol and commonly used as a wetting agent in the calcium and aluminum salt coagulant and found out the made glove working surface of rubber film is non-adhesive, easily stripped from the former and the glove tensile strength is good with a similar performance to conventional calcium salt coagulant made glove. To confirm this result, we further made another trial by adding polyethylene glycol in calcium aluminum salt coagulant, and found out polyethylene glycol made working surface is also non-adhesive, easily stripped and with similar tensile strength of glove. Without by any theory, it is believed that nonionic surfactant can delay or stabilize aluminum ion diffusing in the nitrile rubber film and slow down the function speed with carboxylic acid to prevent from over-vulcanization which can cause poor strength problem. We also found that the non-adhesive working surface is with a strong grip strength and a very clean hand feel which is suitable for dental usage where the dentist requires to hold tools tightly under contact water condition. However, for disposable gloves which are packed in a dispenser box, it is not so easy to pull out the gloves which is caused by the working surface contacted each other and the edge of box opening hole to create abrasion, and in different occasion may require different degree of grip strength or slippery performance of working surface. Therefore, we made another trial by adding wax to adjust the grip strength and found out that working surface is smoother, easier to strip and the and the made glove is softer with better elongation and similar tensile strength compared to without adding wax in compounded carboxylated nitrile latex. It is also believed that when wax is molten and booming out to the glove surface during drying and curing process, it can delay or slow down aluminum ion diffusing into the rubber film to improve the over-vulcanization problem. Based on these trials, we conclude that by adding nonionic surfactant in calcium and aluminum salt coagulant solution can make a non-adhesive working surface without scarifying rubber film strength, while optional adding of a wax in carboxylated nitrile latex can adjust the working surface grip strength with a better elongation.

According to the present invention, a powder free water based coagulant solution comprising of calcium salt is selected from calcium nitrate or calcium chloride, or its combination and aluminum salt is selected from aluminum nitrate, aluminum chloride, aluminum acetate, and aluminum sulfate, or its combination. Meanwhile, a suitable nonionic surfactant is further added in coagulant solution which is selected from ethoxylate and/or propoxylate modified fatty alcohols, ethoxylate and/or propoxylate modified alkyl esters, ethoxylate acetylenic diols, ethoxylated alkyphenol, sorbitan fatty acid esters and/or its polyoxythylene derivatives, polyoxyethylene sorbitol fatty acid esters, glycerol fatty acid esters, polyoxyethlene fatty acid esters, polyoxylene alky amines and/or alkylol amides, polyethylene glycol, polyoxyethylene glycol octylphenol and/or alkylphenol ethers, sorbitan alkyl esters and/or its polyoxyethylene glycol derivatives, or its combination. In addition, the suitable wax of present invention for adjusting the working surface grip force is selected from carnauba, paraffin, microcrystalline, polyethylene and its derivatives, or its combination.

The present invention is demonstrated as following examples and descriptions: The compositions as in TABLE 1 are added in water and the temperature is maintained at about 50° C. for the coagulant solution which is prepared for dipping.

TABLE 1

| Ingredient | CONVEN- | | COMPAR- |
|---|---|---|---|
| (by weight) | TIONAL | CONTROL | ATIVE |
| Calcium nitrate | 12% | 12% | 12% |
| Aluminum nitrate | | 0.5% | 0.5% |
| Fatty alcohol ethoxylate | 0.5% | | 0.5% |
| Calcium stearate | 1.0% | | |

Compounded carboxylated nitrile latex comprising the compositions as in TABLE 2 are prepared and left for 24 hours maturation time before dipping. A commercial available carboxylated nitrile latex is selected comprising about 45% solid content and with a component and ratio base on solid as about 27% acrylonitrile, 67% butadiene and 6% carboxylic acid. EXAMPLE 1 composition is a conventional sulfur based crosslinker formulation, EXAMPLE 1A with additional paraffin wax added in EXAMPLE 1 composition, EXAMPLE 2 composition use sodium aluminum as crosslinker, and EXAMPLE 2A with additional paraffin wax added in EXAMPLE 2 composition.

TABLE 2

| Ingredient | EXAM- | EXAM- | EXAM- | EXAM- |
|---|---|---|---|---|
| (by phr) | PLE 1 | PLE 1A | PLE 2 | PLE 2A |
| Carboxylated nitrile latex | 100 | 100 | 100 | 100 |
| Sulfur | 1.2 | 1.2 | | |
| ZDEC | 1.0 | 1.0 | | |
| ZnO | 1.5 | 1.5 | | |
| Sodium aluminate | | | 0.5 | 0.5 |
| SDBS | 0.3 | 0.3 | 0.3 | 0.3 |
| KOH | 1.5 | 1.5 | 1.5 | 1.5 |
| Paraffin wax | | 1.0 | | 1.0 |

After materials are prepared, the glove samples are made by the following steps:

A) Dip a cleaned ceramic glove former in a coagulant solution and then dry the coagulant.

B) Dip in a compounded nitrile latex to form a layer of film on the former or optional dip in another compounded nitrile latex to get the desired film thickness.

C) Partially drying the film and dip in water of temperature 50° C. to leach out the impurities.

D) Curing the film in a hot oven with temperature around 120° C. for about 20 minutes.

E) The film now is a glove and treated by chlorination process for de-sticky and lubrication, and then strip the glove from the former.

The made glove sample are marked whereas glove made by conventional calcium salt with nonionic surfactant and calcium stearate coagulant is marked CONV, made by control calcium and aluminum salt without nonionic surfactant coagulant is marked CONT, made by comparative calcium and aluminum salt with additional nonionic surfactant coagulant is marked COMP; and glove made by conventional sulfur crosslinking base compounded latex is marked EXP 1, made by with additional wax in EXP1 compounded latex is marked EXP 1A, made by sodium aluminum crosslinker compounded latex is marked EXP 2, and made by with additional wax in EXP 2 compounded latex is marked EXP 2A. The made glove samples are staying for 24 hours before tested according to ASTM D6319 test method for the before aging physical performances as showing in TABLE 3.

TABLE 3

| Physical performance | Tensile strength | Elongation |
|---|---|---|
| (ASTM D6319) | (Mpa) | (%) |
| CONV-EXP 1 | 27.05 | 631.24 |
| CONV-EXP 1A | 26.78 | 646.72 |
| CONT-EXP 1 | 22.32 | 544.78 |
| CONT-EXP 2 | 19.86 | 551.82 |
| COMP-EXP 1 | 27.39 | 557.84 |
| COMP-EXP 2 | 25.25 | 605.95 |
| COMP-EXP 1A | 26.90 | 662.19 |
| COMP-EXP 2A | 25.12 | 637.43 |

From the above test results, we can observe that without addition of nonionic surfactant, the tensile strength and the elongation are generally the lowest values (CONT-EXP 1 and CONT-EXP 2) with tensile strength values of only 22.32 and 19.86 while the elongation values are 544.78 and 551.82 respectively for conventional sulfur base crosslinker formulation and aluminum base crosslinker formulation. After the addition of nonionic surfactant, the tensile strength and elongation further increase and become higher with tensile strength values of 27.39 and 25.25 while the elongation values are 557.84 and 605.95 respectively. We can conclude that adding nonionic surfactant can increase the tensile strength and elongation ASTM physical performance of the glove. This is because the presence of nonionic surfactant can delay or stabilize aluminum ion diffusing in the nitrile rubber film and slow down the function speed with carboxylic acid to prevent from over-vulcanization which can cause poor strength problem.

In addition, the addition of wax can also increase the elongation of the glove. This is proven from TABLE 3 above CONV-EXP 1 without any wax has elongation value of 631.24 while CONV-EXP 1A with addition of wax has higher elongation value of 646.72. Also, COMP-EXP 1 without any wax has elongation value of 557.84 while COMP-EXP 1A with addition of wax has higher elongation value of 662.19. The same goes for COMP-EXP 2 without any wax has elongation value of 605.95 while COMP-EXP 2A with addition of wax has higher elongation value of 637.43. Meanwhile, the tensile strength maintains relatively around the same values in the above examples respectively. Therefore, we can conclude that adding wax can increase the elongation while maintaining the tensile strength of the glove.

Comparing the above test results, we conclude that by adding nonionic surfactant do successfully make a non-adhesive working surface of nitrile glove without scarifying tensile strength performance and optional with addition of wax in carboxylated nitrile latex for decreasing the working surface grip strength and improving stripping, elongation and softness of glove. It is obvious that the present invention provides a better, simple and more effective solution to solve the shortcoming of previous and currently used method of making a powder free, adjustable grip strength working surface of nitrile glove.

The present invention claimed is:

1. A nitrile glove made from dipping in
a powder free water base coagulant solution comprising 8-30% calcium salt, 0.1-1.0% aluminum salt and 0.1-1.0 nonionic surfactant; and
a carboxylated nitrile latex optional with 0.1-2.0 phr wax.

2. A nitrile glove according to claim 1, wherein the calcium salt is selected from either calcium nitrate or calcium chloride, or its combination thereof.

3. A nitrile glove according to claim 1, wherein the aluminum salt is selected from aluminum nitrate, aluminum chloride, aluminum acetate, and aluminum sulfate, or any combination thereof.

4. A nitrile glove according to claim 1, wherein the nonionic surfactant is selected from ethoxylate and/or propoxylate modified fatty alcohols, ethoxylate and/or propoxylate modified alkyl esters, ethoxylate acetylenic diols, ethoxylated alkyphenol, sorbitan fatty acid esters and/or its polyoxythylene derivatives, polyoxyethylene sorbitol fatty acid esters, glycerol fatty acid esters, polyoxyethlene fatty acid esters, polyoxylene alky amines and/or alkylol amides, polyethylene glycol, polyoxyethylene glycol octylphenol and/or alkylphenol ethers, sorbitan alkyl esters and/or its polyoxyethylene glycol derivatives, or any combination thereof.

5. A nitrile glove according to claim 1, wherein the carboxylated nitrile latex is a carboxylated acrylonitrile butadiene latex.

6. A nitrile glove according to claim 1, wherein the wax is selected from carnauba, paraffin, microcrystalline, polyethylene and its derivatives, or any combination thereof.
